(19) United States
(12) Patent Application Publication
(10) Pub. No.: US 2007/0139171 A1
(43) Pub. Date: Jun. 21, 2007

(54) Method for transmitting information and signal transmission system, particularly for access control

(76) Inventor: Harald Fischer, Braubach (DE)

Correspondence Address: MCGRATH, GEISSLER, OLDS & RICHARDSON, PLLC, P.O. BOX 1364, FAIRFAX, VA, 22038-1364, US

(21) Appl. No.: 11/641,713

(22) Filed: Dec. 20, 2006

(30) Foreign Application Priority Data
Dec. 20, 2005 (DE) DE102005060914.7

(51) Int. Cl. B60R 25/10

(52) U.S. Cl. 340/426.2; 340/426.36; 340/426.19; 340/426.28

(57) ABSTRACT

A signal transmission system is disclosed that includes at least one receiving unit, which is designed to receive electromagnetic signals, and at least one transmitting unit, which is designed to transmit an electromagnetic signal, position-dependent at the location of the receiving unit, with a signal vector, Whereby the transmitting unit and the receiving unit have a number of transmitting and receiving means that is smaller than a number required to determine the signal vector relative to all spatial components. The system also includes a memory unit functionally connected to the receiving unit, in which a value field with electromagnetic signal parameters is stored depending on the position of the transmitting unit relative to the receiving unit, and an evaluation unit, which is designed to determine the position of the transmitting unit from the signal vector components determined by the transmitting and receiving unit using the value field. This design of the signal transmission system makes it possible to achieve a more cost-effective realization of the entire system, compared with conventional systems, by reducing the total number of transmitting and receiving devices for electromagnetic signals, particularly in the form of transmitting or receiving coils.

This nonprovisional application claims priority under 35 U.S.C. § 119(a) on German Patent Application No. DE 102005060914, which was filed in Germany on Dec. 20, 2005, and which is herein incorporated by reference.

### BACKGROUND OF THE INVENTION

1. Field of the Invention

The present invention relates to a method for transmitting information between a receiving unit and transmitting unit, mobile with regard to the receiving unit, whereby the transmitting unit transmits an electromagnetic signal, position-dependent at least at the location of the receiving unit, with a signal vector to the receiving unit and whereby the receiving unit receives the electromagnetic signal with a receiving device, particularly an array of coils.

Furthermore, the present invention relates to a signal transmission system for electromagnetic signals and to the use of the signal transmission system according to the invention for access control.

2. Description of the Background Art

For access control, for example, in the case of a passenger vehicle, transmitting units integrated into the vehicle key are routinely used today, which upon activation by a user, for example, by pressing a button, transmit an electromagnetic signal with an access code for the respective vehicle to at least one receiving unit disposed in the vehicle, with at least one antenna system. In so doing, an evaluation unit present in the receiving unit in the form of a microcontroller checks the received access code and accordingly permits access to a vehicle, for example, by unlocking the door closing mechanism. Transmitting units with three mutually orthogonal transmitting devices in the form of transmitting coils, each with coil axes oriented perpendicular to one another, are routinely used in systems of this type, so that substantially an isotropic antenna results for the transmitting unit. This generates, independent of the position of the transmitting unit, for example, a vehicle key, a position-independent field vector for the electromagnetic signal, transmitted by the transmitting unit and to be received by the receiving unit, at the location of the receiving unit. Basically, to achieve position independence for the entire system, a minimum number of four coils are necessary, distributed in the transmitting and receiving units. The number of the antenna systems used in a practical application, for example, in a vehicle, depends on the vehicle type. In addition, an internal/external identification should be possible simultaneously with respect to a relative position of the transmitting unit in regard to the vehicle, which necessitates an accuracy of about 5 cm to about 10 cm in the location determination of the transmitting unit. In practice, for this purpose, in a typical vehicle, for example, three antenna systems are disposed at both B pillars and on the interior mirror of the vehicle. From the signal receiving information of these antenna systems, a suitable evaluation unit can then determine the location/position of the transmitting unit relative to the vehicle using a stored EMC image of the vehicle.

Furthermore, so-called PEG and RKE systems (Passive Entry Go or Remote Keyless Entry, respectively) are known, in which a (passive) transponder is “addressed” by a base station disposed on a physical entity to be controlled, such as a building, and thereupon (in backscatter operation) transmits an access code to the base station. Here also, in relay situations, it is necessary to control the position of the transmitting unit (of the transponder) as well, in addition to the transmitted access code.

It is a disadvantage in the conventional systems that these require a plurality of transmitting or receiving devices in the form of coils in a cost-intensive manner for the signal transmission and particularly for position determination, which is associated with a relatively high space requirement for the respective components.

For example, German Patent Application DE 100 46 897 A1 discloses a method of the aforementioned type. In this case, a so-called ID transmitter has three receiving coils perpendicular to each other in a spatial arrangement, so that the definite determination of a magnetic field at the location of the ID transmitter is possible by evaluating the received field parts. With the additionally present transmitting coils, in the subject of the aforementioned publication, therefore, five coils are provided for signal transmission. It is to be regarded as a particular disadvantage here that this is associated with a relatively high space requirement in a cost-intensive manner for the respective components.

German Patent Application DE 101 59 604 A1, which corresponds to U.S. Pat. No. 6,970,679, which is herein incorporated by reference, describes a system with three mutually orthogonal antennas in the receiving unit.

German Patent Application DE 198 45 649 A1 discloses two mutually orthogonal antenna coils in the transmitter modules and the antenna unit of an ID transmitter, i.e., four coils per transmitter-receiver pair.

### SUMMARY OF THE INVENTION

It is an object of the present invention to provide a method for transmitting information between a receiving unit and a transmitting unit, mobile relative to the receiving unit, and a signal transmission system for electromagnetic signals, which, in comparison with the related art, operates in a more cost-effective manner with fewer transmitting and receiving devices.

The object is achieved, in one respect, in a method in that the signal vector is underdetermined relative to its spatial components by the receiving device and that the receiving unit determines a position of the transmitting unit from the determined components of the signal vector with use of a stored value field.

Furthermore, the invention proposes achieving the object with a signal transmission system for electromagnetic signals, whereby the signal transmission system comprises: at least one receiving unit, which is designed to receive electromagnetic signals, and at least one transmitting unit, which is designed to transmit an electromagnetic signal, position-dependent at the location of the receiving unit, with a signal vector, whereby the transmitting unit and the receiving unit have a number of transmitting and receiving means that is smaller than a number required to determine the signal vector relative to all spatial components; a memory unit functionally connected to the receiving unit, in which a value field with electromagnetic signal parameters is stored depending on a position of the transmitting unit relative to the receiving unit; and an evaluation unit, which is designed to determine the position of the transmitting unit from the signal vector components determined by the transmitting and receiving unit using the value field.

Here and in the further course of the present description, the term “position” includes, for example, the totality of the parameters/coordinates necessary to describe an arrangement of the transmitting unit in space relative to the receiving unit, i.e., in each case three degrees of freedom for the location and for the orientation in space.

According to the basic concept of the present invention, the determination of the position of the transmitting unit relative to the receiving unit occurs with use of a position-dependent electromagnetic signal and with use of a value field stored in the receiving unit, as a result of which considerable reduction of the transmitting and receiving devices in the total system of the transmitting and receiving unit can be achieved, for example, in the form of coils.

For example, it is thereby possible to reduce the total coil number to only two or three coils, because achieving position independence particularly of the transmitting unit is no longer necessary. The electromagnetic signal parameters stored in the value field can be, for example, its amplitude and/or phase position.

Accordingly, in an embodiment, the signal transmission system of the invention provides that the transmitting unit has only a single transmitting coil for transmitting the electromagnetic signal. In another embodiment, alternatively or in addition, it is provided that the receiving unit has a number of less than three receiving coils, preferably two receiving coils, to receive the electromagnetic signal. In a highly simplified embodiment of the entire system, it can be provided thereby that both the transmitting unit and the receiving unit each have only a single transmitting or receiving coil.

In an embodiment, for the purpose of the simplest evaluation possible of the received electromagnetic signal to determine the position of the transmitting unit, it is provided that the value field is stored in the form of a ROM table and that a search of the ROM table provides the position of the transmitting unit. Accordingly, the value field is stored in the form of a ROM table in the memory unit. In this way, the position of the transmitting unit can be determined with a simple search of the ROM table without costly computations and an accordingly costly design of the evaluation unit.

A change in the transmitting unit position can be determined by a search, repeated over time, in the value field and a, movement of the transmitting unit, for example, speed, from the change in position. Furthermore, a position of the transmitting unit can also be determined by a search, repeated over time, in the value field in cases in which an initially determined parameter of the received electromagnetic signal cannot be found in the stored value field or found only in an ambiguous way.

Because the stored value field understandably cannot contain all possible values of electromagnetic signal parameters for reasons of memory technology, but rather has a certain “granularity,” interpolation and extrapolation techniques and certain fuzzy conditions can be used in determining the position of the transmitting unit in a manner known per se, whereby in the last case a measured parameter is also assigned a specific position of the transmitting device when the measured parameter does not agree 100% with a corresponding stored value.

It is provided in addition in the development of the method of the invention that a useful signal, such as an access code, is transmitted with the electromagnetic signal. Accordingly, a development of the signal transmission system of the invention provides that the evaluation unit is designed to determine a useful signal, such as an access code, from the electromagnetic signal. In this regard, for example, conventional current modulation techniques, such as ON-OFF keying, can be used, which are familiar to the person skilled in the art. Furthermore, depending on the useful signal and the determined position of the transmitting unit, a control signal for a functional unit, such as an access control device, can be triggered. In this way, the signal transmission system of the invention can be used for access control, whereby the receiving unit is disposed in a physical entity to be controlled, such as a vehicle or building, and whereby the receiving unit further has a control unit, by which depending on the determined position of the transmitting unit an access control signal can be triggered for an access control element, e.g., a door, of the physical entity to be controlled. Nevertheless, the area of application of the present invention is not limited to access control. Thus, the present invention can be used in an advantageous manner, for example, also in the field of tire pressure measurement (TPM) or the like.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic block diagram of a signal transmission system according to an embodiment of the invention;

FIG. 2 is a detailed (block) diagram of the transmitting unit and receiving unit of the signal transmission system of the embodiment illustrated in FIG. 1;

FIG. 3 is a schematic drawing of the relative arrangement of transmitting and receiving coils in the transmitting or receiving unit of FIG. 2;

FIG. 4 is a schematic drawing for determining a position of the transmitting unit relative to the receiving unit;

FIG. 5 is a schematic drawing of a stored value field for determining a position of the transmitting unit; and

FIG. 6 is a flow diagram to depict a sequence of the method of the invention.

### DETAILED DESCRIPTION

FIG. 1 shows a signal transmission system 1 of the invention with a mobile transmitting unit 2 and a receiving unit 3. According to the exemplary embodiment of FIG. 1, receiving unit 3 for access control is disposed within a physical entity 4 to be controlled, for example, a vehicle. Transmitting unit 2 is designed to transmit electromagnetic signals 5 to receiving unit 3, as will be described in further detail hereafter.

Receiving unit 3 has a receiving device 6 for receiving the electromagnetic signal 5 from transmitting unit 2. Furthermore, receiving unit 3, functionally connected to receiving device 6, has an evaluation unit 7, which furthermore is functionally connected to a memory unit 8, e.g., a mass memory. A value field 9 with parameters of the electromagnetic signal 5 is stored in the form of a ROM table in memory unit 8. Moreover, evaluation unit 7 is linked to a control unit 10, which in turn is linked to at least one access control element 11 of the physical entity 4 to be controlled, for example, a door or the like.

According to an embodiment, the transmitting unit 2, to reduce the complexity of the entire transmission system 1, transmits an electromagnetic signal 5, position-dependent relative to receiving device 6 in receiving unit 3; i.e., the electromagnetic signal 5 received at the location of receiving device 6 in regard to its parameters, such as amplitude and/or direction of the field vector, depends on the position of transmitting unit 2 relative to receiving device 6. The electromagnetic signal 5 thus received by receiving device 6 is evaluated by evaluation unit 7. In the device, the unit compares the measured signal with corresponding entries in the value field 9, which is stored in memory unit 8 of receiving unit 3. By comparing the received signal 5 with the stored value field 9, evaluation unit 7 is capable of determining where, i.e., in which position, transmitting unit 2 is relative to receiving unit 3. Depending on a result of this determination, evaluation unit 7 can then instruct control unit 10 to send a specific control signal KS to access control element 11, for example, a control signal to release access control element 11, for example, to open a door or the like. Moreover, evaluation unit 7 according to the invention is designed further to identify or evaluate an access code transmitted with electromagnetic signal 5 and to control control unit 10 depending on the aforementioned comparison result and the previously described evaluation of the access code.

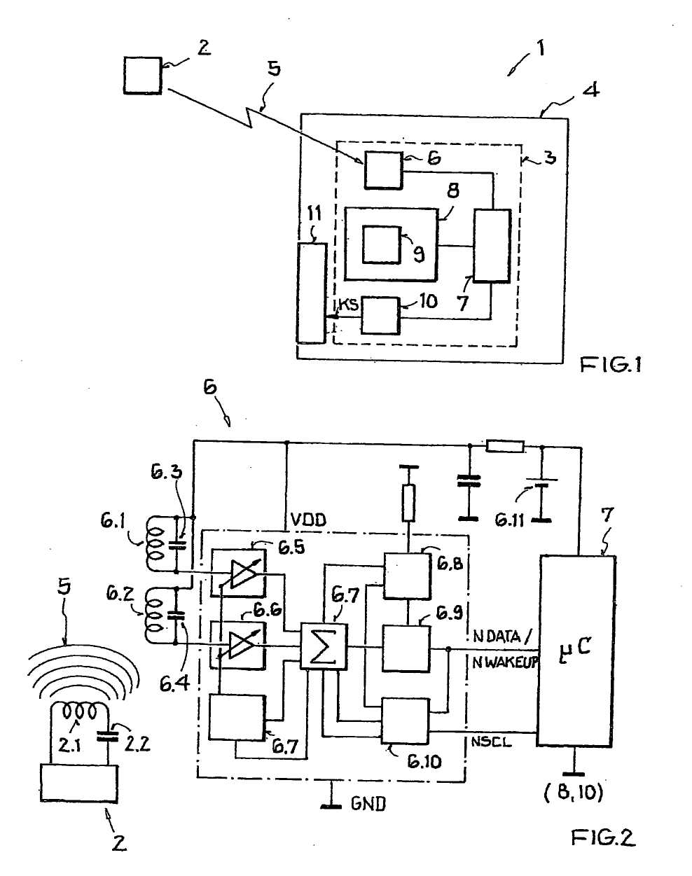

In this way, it is possible according to the invention, for example, to release access control element 11 only when receiving device 6 receives a correct access code, i.e., one of the access codes assigned to the specific physical entity 4 to be controlled, from a transmitting unit 2, whereby the latter must be disposed in addition in a certain position (or a certain position area) with regard to distance and/or orientation from physical entity 4 to be controlled, in order to prevent, for example, relay problems. The devices and methods used hereby within the previously generally described signal transmission system 1 of the invention will be described more fully hereafter with the use of FIGS. 2 to 6.

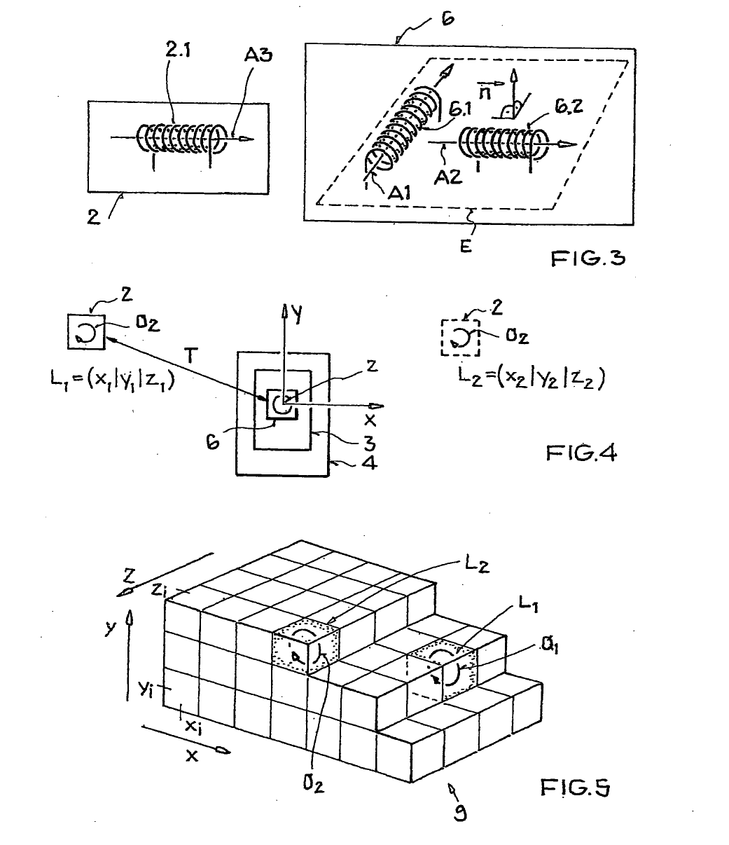

FIG. 2 shows in a detailed drawing transmitting unit 2 and receiving unit 3 of the signal transmission system of the invention according to FIG. 1. Transmitting unit 2, which according to the invention can be designed as an actively or passively transmitting unit, has as a transmitting device a single coil 2.1, which is connected in series to a capacitor 2.2. Within the scope of a preferred embodiment of the present invention, the previously described transmitting unit 2 is integrated into a vehicle key or a transponder. Furthermore, receiving device 6 of receiving unit 3 according to FIG. 1 is shown as a detailed block diagram in FIG. 2. According to the shown embodiment, receiving device 6 has two receiving coils 6.1 or 6.2, to which a capacitor 6.3 or 6.4 is connected in parallel. The relative arrangement of coils 6.1, 6.2, or the corresponding coil axes will be discussed in greater detail with use of FIG. 3. Each of the two coils 6.1, 6.2 is assigned a controllable amplifier 6.5 or 6.6. Their outputs are connected to a correlator/adder 6.7, to which a timer unit 6.8, a header detection unit 6.9, and a serial interface 6.10 are connected in turn downstream in a manner known per se. The outputs, designated by NDATA/NWAKEUP or NSCL, of the header detection unit 6.9 or the serial interface 6.10 are connected to evaluation unit 7 (FIG. 1), which can be designed, for example, as a microcontroller (for example, as an 8-bit AVR). The voltage supply both for receiving device 6 and evaluation unit 7 occurs by means of a voltage source 6.11 (supply voltage VDD).

During operation of the device described above, coils 6.1, 6.2 receive electromagnetic signal 5 transmitted by transmitting unit 2, whereby the signal parts received by the specific coils and the total signal, combined therefrom, vary depending on position due to the design of transmitting unit 2, according to the invention, with only one transmitting coil 2.1. The signal parts, received by coils 6.1 or 6.2, are amplified by amplifier 6.5 or 6.6, whereupon a signal addition occurs in correlator/adder 6.7 according to amount and phase. The thus obtained total signal, particularly after further processing to recognize the header information or the like, like the individually received signal parts is then supplied to evaluation unit 7, which is initially designed in a manner known per se to obtain an access code from electromagnetic signal 5 transmitted by transmitting unit 2, e.g., by demodulation. The access code can then be evaluated, for example, for the release of access control element 11.

In this regard, it is possible, on the one hand, according to the invention to dispense with providing a separate correlation step in correlator/adder 6.7, when, for example, all received signal parts can be sufficiently determined separately to be able to perform, apart from the sum formation to obtain the access code, also the following position determination of the invention, which will be described in greater detail hereafter. On the other hand, situations can arise in which the received signal is so weak relative to at least a received component (signal part) that although a sum results, the signal parts themselves cannot be assigned for position determination (see below). Here, a measured value, determined real-time, of a transmitting location adjacent to the current transmitting location (location of the transmitting unit; cf. FIGS. 4 and 5) may then be used as a correlated value, which according to the shown exemplary embodiment, can be controlled by the correlation step of correlator/adder 6.7. In this regard, the correlation step in particular can be designed for at least volatile storing and then providing of such correlated measured values. However, it is also possible according to the invention to provide the last named functionality by means of evaluation unit 7 in conjunction with memory unit 8.

In order to avoid relay problems within the scope of an access control, it is furthermore essential, particularly in PEG systems, to link the obtained information using an access code transmitted by transmitting unit 2, with information on a position of transmitting unit 2 with respect to receiving unit 3. The additional consideration of this type of position information is also important in cases in which transmitting unit 2 can be located within the physical entity 4 to be controlled, for example, within a vehicle interior, whereby in such cases it must be assured via reliable position recognition that access to the physical entity 4 to be controlled is not blocked for a person, as long as transmitting unit 2, for example, the vehicle key, is located within the physical entity to be controlled.

To assure a reliable position recognition according to the invention despite the provision of a total of only three transmitting and receiving coils 2.1, 6.1, 6.2 according to FIG. 2, it is provided according to the invention, as shown in FIG. 3, to arrange the receiving coils 6.1, 6.2 relative to their respective coil axes A1 or A2 in such a way that a plane E, spanning the coil axes A1, A2, perpendicular to which, i.e., in a direction parallel to the plane normal vector \vec{n} no receipt of electromagnetic signal 5 is possible, is directed as favorably as possible to an assumed preferential direction of transmitting unit 2 or transmitting coil 2.1 with coil axis A3. In other words: Coils 6.1, 6.2, or their coil axes A1, A2 according to the invention are preferably arranged in such a way that the normal vector \vec{n} of plane E does not coincide with a presumably preferred direction of coil axis A3 of transmitting coil 2.1, whereby coil axes A1, A2 need not be perpendicular to one another but can essentially accommodate any angle. In this way, according to the invention, despite the provision of a total of only three transmitting or receiving coils, as gap-free a receipt as possible of electromagnetic signal 5, transmitted by transmitting unit 2, (FIGS. 1, 2) is possible.

If it is assumed that the transmitting unit is located at a specific location relative to the receiving device and has a certain orientation, then basically a certain signal vector S with components S₁, S₂, S₃, of which, however, according to the present exemplary embodiment only two components, e.g., S₁, S₂, are determined, results at the location of the receiving device. Thus, in principle, any vector S, S′, . . . with components S₁, S₂ represents the “sought” signal vector S, whose location determination (location of the transmitting unit) was measured beforehand according to the invention and, as already indicated, was stored in the memory. In other words: A measured component pair S₁, S₂ according to the invention is assigned at least one stored value pair of a location within the space around the receiving device and of a corresponding S3 value, so that based on the measured components S₁, S₂ both the S₃ value and also the location or a specific location area can be determined. The problem of ambiguities will be discussed further in greater detail hereafter.

Thereby, according to the invention, the presence of a third receiving coil in the receiving device is necessary only with raw data uptake to determine the aforementioned memory values, in order to be able to determine in this manner, independent of the position, the complete signal vector S depending on the transmitting location.

FIG. 4 illustrates the nomenclature used in the present description with respect to the position Lᵢ of transmitting device 2 relative to physical entity 4 to be controlled or receiving unit 3/receiving device 6 contained therein. In FIG. 4, two possible positions L₁, L₂ of transmitting unit 2 are shown. Each of the positions L₁, L₂ is first described with respect to space by a coordinate triple (x₁/y₁/z₁) or (x₂/y₂/z₂). In this case, the individual coordinates xᵢ, yᵢ, zᵢ provide the coordinate values relative to the mutually orthogonal spatial directions x, y, and z, also shown in FIG. 4. Each of the aforementioned coordinate triples indicates a location in three-dimensional space around physical entity 4 to be controlled, at which transmitting unit 2 can be located. In addition, transmitting unit 2 at any such described location in space can assume any orientation, which is designated in FIG. 4 with O₁, O₂ and by a corresponding closed arrow. This type of orientation can be indicated, for example, by means of two angles relative to a reference plane (for example, an elevation and azimuth angle). The origin of the coordinate system shown in FIG. 4 is situated here at the location of receiving device 6 (cf. FIG. 1). In this way, the specific coordinate triples (xᵢ/yᵢ/zᵢ) further define a (Euclidian) distance r of transmitting unit 2 from receiving unit 3/receiving device 6. Depending on this distance r and the specifically taken orientation Oᵢ of transmitting unit 2, a specific signal course for the received electromagnetic signal 5 now results at the location of receiving unit 3/receiving device 6. In this case, basically an infinite number of possible signal courses according to all possible assumable orientations Oᵢ of transmitting unit 2 is basically assigned to each coordinate triple (of an infinite number of coordinate triples). According to the invention, however, only a finite number of possible parameters can be stored for each coordinate triple in the value field 9 stored in memory unit 8 (FIG. 1), as is symbolically depicted below with use of FIG. 5.

FIG. 5 shows a partial schematic depiction of value field 9 which is stored in memory unit 8 and is designed according to the shown exemplary embodiment as a multilayer characteristic diagram. The coordinate triples, already described above with use of FIG. 4, are symbolized in the drawing according to FIG. 5 by cubic structures, whereby the number of cube is determined by the intended accuracy of the (discrete, “granular”) value scales in the specific spatial direction x, y, z. In the drawing of FIG. 5, the “cubes,” assigned to the two positions L₁ and L₂ of FIG. 4, are drawn shaded. Each of the cubes shown in FIG. 5 has a further subdivision to show orientations Oᵢ possible for each position of the transmitting unit; this is not shown explicitly in FIG. 5 but only again by the circular closed arrows. In other words: Each of the cubes shown in FIG. 5 is in turn subdivided by an appropriate arrangement of cubes, whereby each of these “sub-cubes” indicates a memory region of memory unit 8 for storing parameters for electromagnetic signal 5 for a specific (discrete) location and a specific (discrete) orientation of transmitting unit 2 relative to receiving unit 3/receiving device 6. Evaluation unit 7 of the inventive signal transmission system 1 is accordingly designed to access these memory regions and thus by means of a search in stored value field 9 to conclude the position and orientation of the transmitting device based on a comparison of measured parameters of electromagnetic signal 5. For the purposes of evaluation, in this case, however, routinely only the location (and not the orientation) of the transmitting device is necessary. Thus, for example, as a rule it is not critical how the transmitting device is precisely oriented relative to the receiving device, as long as it is within the permissible distance from the receiving device, whereas according to the above statements, however, knowledge of the orientation is absolutely necessary to determine the location.

The following table illustrates, by way of example, the values, e.g., stored in the form of a ROM table, for one of the aforementioned “cubes” Lᵢ, i=1, 2, i.e., a specific spatial region in memory unit 8.

| Spatial region | Measured values | | |
|---|---|---|---|
| Lᵢ | S1 | S2 | S3 |

| | | |
|---|---|---|
| 1F | AF | EF |
| 2F | BF | FF |
| 3F | CF | 0F |
| . . . | . . . | . . . |

With a measured signal component pair (S1/S2)=(1F, AF), a search according to the invention in the stored value field thus produces an, optionally not yet definite, S₃ value of EF, whereby the transmitting unit is located in spatial region Lᵢ (so-called “key field”). This evaluation in the present exemplary embodiment is made by evaluation unit 7 (microcontroller; cf. FIG. 1).

Certain intermediate values, which because of the discrete formation of the characteristic diagram according to FIG. 5 are not explicitly contained in it, can be found, for example, in that for the addressed comparison of the actual value (measured value) and the target value (stored value) a certain “inaccuracy criterion” is defined, so that a certain characteristic diagram value is also regarded as having been found when the measured value deviates therefrom within certain limits.

The movement parameters of transmitting device 2 can likewise be determined from the value field or multilayer characteristic diagram according to the invention. If, for example, at a first time t₁ a parameter, assigned to the cube L₁, of electromagnetic signal 5 is determined and stored in evaluation unit 7, and at a later time t₂ a parameter, assigned to cube L₂ of the characteristic diagram, of electromagnetic signal 5 is determined, thus a movement parameter for transmitting unit 2, for example, its speed, can be determined from the coordinate difference (ΔX, ΔY, ΔZ)=(X₂−X₁, Y₂−Y₁, Z₂−Z₁) divided by the corresponding time difference Δt (=t₂−t₁).

If because of an unfavorable relative orientation of the coil axes A1-A3 of the transmitting or receiving coils (cf. FIG. 3) a receipt gap were to occur at the location of receiving unit 3/receiving device 6, then this negative effect is easily compensated in practice so that the transmitting unit 2, normally found in the hand or on the body of an operator, is designed as not stationary but mobile, so that accordingly even within a short time due to a changed relative position of transmitting unit 2 and receiving unit 3, according to the drawing in FIG. 3, again a receipt at the location of receiving unit 3/receiving device 6 is assured. The same effect can also be used to compensate for possible ambiguities of the multilayer characteristic diagram of FIG. 5 in that within a short time period a plurality of positions Lᵢ of transmitting unit 2 are determined, whereby the position Lᵢ, determined for a specific time tᵢ, is stored in evaluation unit 7 (FIG. 1). If accordingly for a certain sequence of determined parameters of electromagnetic signal 5 in each case a plurality of positions were to be determinable from the characteristic diagram, then according to the invention an appropriate selection can be made based on the assumption that all positions Lᵢ determined within a short time interval receiving Δt, according to the drawing in FIG. 5, must belong to a single cube or closely adjacent cubes of the characteristic diagram. Ambiguities of the stored characteristic diagram can be compensated for in this way, as stated.

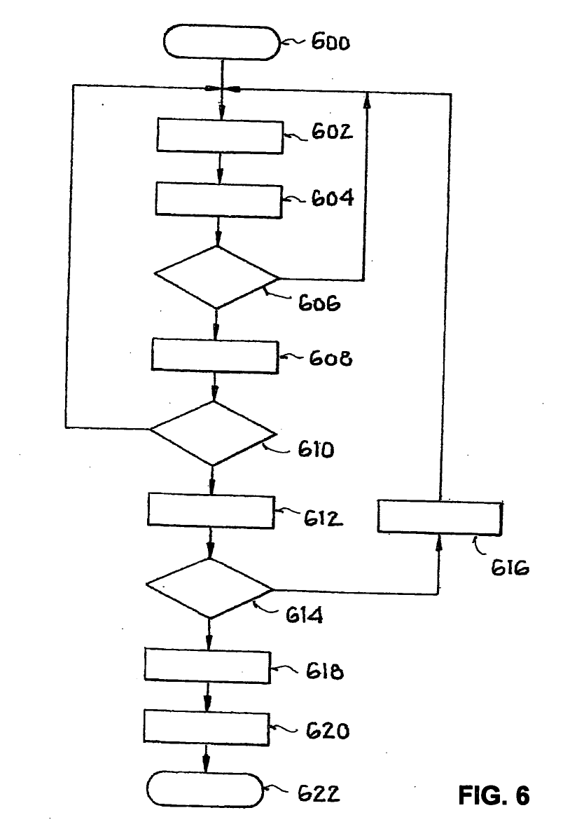

FIG. 6 shows a flow chart of an embodiment of the method of the invention. The process begins with step 600. In a next step 602, transmitting device 2 transmits an electromagnetic signal 5, according to FIG. 1 and 2, to receiving unit 3. In so doing, the transmission of the electromagnetic signal by transmitting unit 2 or by the action of an operator himself can be initiated, for example, in that the operator actuates a device provided on transmitting unit 2 (for example, a switch or key). Alternatively, the transmission of the electromagnetic signal by transmitting unit 2 can also be triggered or initiated by receiving unit 3, for example, in that it transmits an appropriate signal to transmitting unit 2, whereupon it is prompted to transmit electromagnetic signal 5, for example, in backscatter operation, whereby, for example, the receiving coils of the receiving device according to FIG. 2 are used as transmitting coils for transmitting the aforementioned signal to the transmitting unit. In a next step 604, receiving unit 3 or its receiving device 6 receives the electromagnetic signal transmitted by transmitting unit 2. Next, it is determined in a query 606, whether the received signal was received with a sufficient signal strength for an evaluation. If this is not the case (no), the process is continued with the already described step 602. Otherwise (yes), evaluation unit 7 (FIG. 1) determines a parameter of the measured electromagnetic signal, for example, its amplitude, and then performs a search in stored value field 9, whereby it attempts to determine a value corresponding to the parameter in it (step 608). Next, in step 610 another query is made whether a corresponding value or a value deviating within predefined limits was found within the stored value field. If this is not the case (no), the process is again continued with step 602. Otherwise (yes), the position of the transmitting unit is determined using the respective value field entry, whereby ambiguities may result, when one of the same parameter is contained repeatedly in the stored value field (step 612). Then, in step 614 a query is made whether the thus determined position of the transmitting unit is definite or not. In the case of ambiguities (no), the determined position in step 616 is stored temporarily in evaluation unit 7, and the process returns to step 602, to determine at least one other position of the transmitting unit, so that then the ambiguity can be resolved, as described above. If the query in step 614 indicates that the position of the transmitting unit and thereby its location were definitely determined (yes), thus the evaluation unit in step 618 generates an appropriate signal to control unit 10 (FIG. 1). For the case that, furthermore, an access code transmitted together with electromagnetic signal 5 is identified by evaluation unit 7 and could be verified (which is not explicitly shown in the present FIG. 6), control unit 10 in a following step 620 produces a control signal KS to access control element 11, shown in FIG. 1, so that it releases the access to physical entity 4 to be controlled. The process ends with step 622.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for transmitting information between a receiving unit and a transmitting unit that is mobile relative to the receiving unit, the method comprising:
transmitting an electromagnetic signal with a signal vector, which is position-dependent at least at a location of the receiving unit, to the receiving unit;
receiving, by the receiving unit, the electromagnetic signal with a receiving device or an array of coils, the signal vector being underdetermined relative to its spatial components by the receiving device; and
determining the position of the transmitting unit from determined components of the signal vector with use of a stored value field.

2. The method according to claim 1, wherein the value field is stored in a ROM table, and wherein a search of the ROM table provides the position of the transmitting unit.

3. The method according to claim 1, wherein a change in the location of the transmitting unit is determined by a search, repeated over time, in the value field and a movement of the transmitting unit from the change in location.

4. The method according to claim 1, wherein a useful signal or an access code, is transmitted with the electromagnetic signal.

5. The method according to claim 1, wherein, depending on the determined position of the transmitting unit, a control signal is generated for a functional unit and/or for access control.

6. A signal transmission system comprising:
at least one receiving unit for receiving an electromagnetic signal;
at least one transmitting unit for transmitting the electromagnetic signal, position-dependent at the location of the receiving unit, with a signal vector, the transmitting unit and the receiving unit having a number of transmitting and receiving devices that is smaller than a number required to determine the signal vector relative to all spatial components;
a memory unit operably connected to the receiving unit, in which a value field with electromagnetic signal parameters is stored depending on a position of the transmitting unit relative to the receiving unit; and
an evaluation unit, which is designed to determine the position of the transmitting unit from the signal vector components determined by the transmitting and receiving unit using the value field.

7. The signal transmission system according to claim 6, wherein the value field is stored in a ROM table in the memory unit.

8. The signal transmission system according to claim 6, wherein the transmitting unit has a single transmitting coil for transmitting the electromagnetic signal.

9. The signal transmission system according to claim 6, wherein the receiving unit has a number of less than three receiving coils to receive the electromagnetic signal.

10. The signal transmission system according to claim 6, wherein the evaluation unit determines a useful signal and/or an access code from the electromagnetic signal.

11. The signal transmission system according to claim 10, wherein, depending on the useful signal and the position of the transmitting unit, a control signal for a functional unit and/or an access control device is triggered.

12. The signal transmission system according to claim 6, wherein, for access control, the receiving unit is provided in a physical entity, and wherein the receiving unit further comprises a control unit, via which, depending on a determined position of the transmitting unit, an access control signal is triggered for an access control element of the physical entity to be controlled.

13. The signal transmission system according to claim 12, wherein the physical entity is a building or a vehicle.

14. The signal transmission system according to claim 6, wherein the receiving unit has two receiving coils to receive the electromagnetic signal.
